(19) United States
(12) Patent Application Publication
(10) Pub. No.: US 2023/0111109 A1
(43) Pub. Date: Apr. 13, 2023

(54) Mortar composition based on isocyanate amine adducts, multi-component resin system, method for the fastening of construction elements and use of the multi component resin system for the fastening of construction elements

(71) Applicant: Hilti Aktiengesellschaft, Schaan (LI)

(72) Inventors: Christian PLENK, Kaufering (DE); Christoph Driemeyer, Augsburg (DE)

(73) Assignee: Hilti Aktiengesellschaft, Schaan (LI)

(21) Appl. No.: 17/905,762

(22) PCT Filed: Mar. 10, 2021
(86) PCT No.: PCT/EP2021/055982

§ 371 Date: Sep. 6, 2022

(30) Foreign Application Priority Data
Mar. 20, 2020 (EP) 20164633.8

(51) Int. Cl. C08G 18/32; C04B 26/16

(52) U.S. Cl. CPC C08G 18/3225; C04B 26/16; C04B 2111/00715

(57) ABSTRACT

A multi-component resin system can be used for producing a mortar composition based on isocyanate amine adducts for the chemical fastening of construction elements. A mortar composition based on isocyanate amine adducts can be produced from the multi-component resin system. A corresponding method can be used for the chemical fastening of construction elements in mineral substrates, using the mortar composition based on the isocyanate amine adducts.

The present invention relates to a multi-component resin system for producing a mortar composition based on isocyanate amine adducts for the chemical fastening of construction elements. The invention also includes a mortar composition based on isocyanate amine adducts produced from the multi-component resin system. The present invention also relates to a method for the chemical fastening of construction elements in mineral substrates and to the use of a mortar composition based on the isocyanate amine adducts for the chemical fastening of construction elements in mineral substrates.

Binder systems based on radically curing compounds such as methacrylate resins or based on epoxy resins reacted with amine curing agents are usually used to produce mortar compositions for the chemical fastening of construction elements, such as anchor rods, reinforcing bars and screws in boreholes. There are numerous commercially available products based on these binder systems.

However, the known binder systems have inadequate properties, especially under critical external conditions, such as elevated temperatures, uncleaned boreholes, damp or water-filled boreholes, diamond-drilled boreholes, boreholes in cracked concrete, etc.

In addition to developing and improving the existing binder systems, efforts are therefore also being made to examine binder systems other than those mentioned above with regard to their suitability as a basis for mortar compositions for chemical fastening. For example, EP 3 447 078 A1 describes a chemical anchor which is produced from a 30 multi-component composition which comprises a polyisocyanate component and a polyaspartic acid ester component. When the two components are mixed, polyurea is formed in a polyaddition reaction, which forms the binder of the mortar composition.

Over their life cycle, often of several decades, mortar compositions for the chemical fastening of construction elements are exposed to changing weather conditions, such as large temperature fluctuations. Even in temperate climates, such as in Europe, the temperature difference between summer and winter is between 40 and 50° C. In countries with very high average temperatures, such as the United Arab Emirates, the mortar compositions are exposed to extreme temperatures of above 50° C. For safety reasons, it is essential to ensure that the mortar compositions used are able to withstand temperature fluctuations or high temperatures without any significant drop in their failure loads. In general, this property is referred to as temperature resistance.

Many mortar compositions based on radically curing compounds, such as methacrylate resins, or epoxy resins have inadequate or insufficient temperature resistance. The chemical anchor described in EP 3 447 078 A1 also has insufficient temperature resistance, although the failure loads under reference conditions (24 hours curing at room temperature) demonstrate that cured mortar compositions based on isocyanates and aspartic acid esters are potentially suitable as binders for chemical anchors.

The object of the present invention is therefore to provide a mortar composition based on isocyanate amine adducts which is suitable for fastening purposes. By comparison with conventional mortar compositions, the mortar composition should have improved temperature resistance together with a comparably high pull-out strength under reference conditions. In particular, the object of the present invention is to provide a mortar composition based on isocyanate amine adducts which has improved pull-out strength at elevated temperatures, such as at 80° C.

The object of the invention is achieved by providing a multi-component resin system according to claim 1. Preferred embodiments of the multi-component resin system according to the invention are provided in the dependent claims, which may optionally be combined with one another.

The invention also relates to a mortar composition according to claim 11 which is intended for the chemical fastening of construction elements and is produced from the multi-component resin system according to the invention.

The invention also relates to a method according to claim 12 for the chemical fastening of construction elements in mineral substrates and to the use of the multi-component resin system according to the invention or the mortar composition produced therefrom according to claim for the chemical fastening of construction elements in mineral substrates.

A first aspect of the invention relates to a multi-component resin system comprising at least one isocyanate component (A) and at least one amine component (B),
the isocyanate component (A) comprising
   at least one aliphatic and/or aromatic polyisocyanate having an average NCO functionality of 2 or more, the amine component (B) comprising
   at least one amine which is reactive to isocyanate groups and has an average NH functionality of 2 or more,
      characterized in that the multi-component resin system is free of polyaspartic acid esters, and
      the isocyanate component (A) and/or the amine component (B) comprises at least one filler and at least one rheology additive, and
      in that the total filling level of a mortar composition produced by mixing the isocyanate component (A) and the amine component (B) is in a range from 30 to 80%.

It has surprisingly been found that the presence of polyaspartic acid esters in isocyanate-amine-based binder systems used in mortar compositions for chemical fastening has a negative influence on the temperature resistance of the cured mortar compositions. In particular, corresponding systems have a greatly reduced bond stress at elevated temperatures, such as 80° C.

It is therefore essential to the invention that the multi-component resin system and in particular the amine component (A) of the multi-component resin system be free of polyaspartic acid esters. The expression “free of polyaspartic acid esters” in the context of the present application means that the proportion of polyaspartic acid esters in the multi-component resin system is preferably less than 2 wt. %, more preferably less than 0.5 wt. % and even more preferably less than 0.1 wt. %, based in each case on the total weight of the multi-component resin system. The presence of polyaspartic acid esters in the aforementioned weight percentage ranges can be attributed to potential impurities.

The proportion of polyaspartic acid esters in the multi-component resin system is, however, particularly preferably 0.0 wt. %, based on the total weight of the multi-component resin system.

For better understanding of the invention, the following explanations of the terminology used herein are considered to be useful. Within the meaning of the invention:
A “multi-component resin system” is a reaction resin system that comprises a plurality of components stored separately from one another, so that curing takes place only after all components have been mixed.
“Isocyanates” are compounds that have a functional isocyanate group —N═C═O and are characterized by the structural unit R—N═C═O.
“Polyisocyanates” are compounds that have at least two functional isocyanate groups —N═C═O; diisocyanates, which are also covered by the definition of polyisocyanate, are characterized, for example, by the structure O═C═N—R—N═C═O and thus have an NCO functionality of 2.
“Average NCO functionality” describes the number of isocyanate groups in the compound; in the case of a mixture of isocyanates, the “averaged NCO functionality” describes the averaged number of isocyanate groups in the mixture and is calculated according to the formula: averaged NCO functionality (mixture)=Σ average NCO functionality (isocyanate i)/nᵢ, i.e. the sum of the average NCO functionality of the individual components divided by the number of individual components.
“Isocyanate component (A)” or also A component describes a component of the multi-component resin system which comprises at least one polyisocyanate and optionally at least one filler and/or at least one rheology additive and/or further additives.
“Amines” are compounds which have a functional NH group, are derived from ammonia by replacing one or two hydrogen atoms with hydrocarbon groups and have the general structures RNH₂ (primary amines) and R₂NH (secondary amines) (see: IUPAC Compendium of Chemical Terminology, 2nd ed. (the “Gold Book”), compiled by A. D. McNaught and A. Wilkinson, Blackwell Scientific Publications, Oxford (1997)).

The compound class of polyaspartic acid esters is explicitly excluded from the term amines in the context of the present inventions. These are defined separately under the term polyaspartic acid esters.
“NH functionality” describes the number of active hydrogen atoms that can react with an isocyanate group in an amino group.
“Average NH functionality” describes the number of active hydrogen atoms that can react with an isocyanate group in an amine and results from the number and NH functionality of the amino groups contained in the compound, i.e. the amine; in the case of a mixture of amines, the “averaged NH functionality” describes the averaged number of active hydrogen atoms in the mixture and is calculated according to the formula: averaged NH functionality (mixture)=F average NH functionality (amine i)/nᵢ, i.e. the sum of the average NH functionality of the individual components divided by the number of individual components.
The term “polyaspartic acid esters” refers to compounds of the general formula (1):

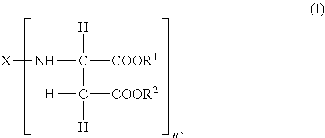

in which
   R¹ and R² can be the same or different and represent an organic group which is inert to isocyanate groups,
      X represents an n-valent organic group which is inert to isocyanate groups, and
      n represents an integer of at least 2, preferably from 2 to 6, more preferably from 2 to 4 and particularly preferably 2.
“Isocyanate amine adducts” are polymers that are formed by the polyaddition reaction of isocyanates with amines. The isocyanate amine adducts according to the invention are preferably polyureas which comprise at least one structural element of the form —[—NH—R—NH—NH—R′—NH—].
“Amine component (B)” or B component a component of the multi-component resin system which comprises at least one amine which is reactive to isocyanate groups, and optionally at least one filler and/or at least one rheological additive and/or further additives.
“Aliphatic compounds” are acyclic or cyclic, saturated or unsaturated carbon compounds, excluding aromatic compounds.
“Alicyclic compounds” are aliphatic compounds having a carbocyclic ring structure, excluding benzene derivatives or other aromatic systems.
“Araliphatic compounds” are aliphatic compounds having an aromatic backbone such that, in the case of a functionalized araliphatic compound, a functional group that is present is bonded to the aliphatic rather than the aromatic part of the compound.
“Aromatic compounds” are compounds which follow Hückel's rule (4n+2).
A “two-component reaction resin system” means a reaction resin system that comprises two separately stored components, in the present case an isocyanate component (A) and an amine component (B), so that curing takes place only after the two components have been mixed.
The term “mortar composition” refers to the composition that is obtained by mixing the isocyanate component (A) and the amine component (B) and as such can be used directly for chemical fastening.
The term “filler” refers to an organic or inorganic, in particular inorganic, compound.
The term “rheology additive” refers to additives which are able to influence the viscosity behavior of the isocyanate component (A), the amine component (B) and the multi-component resin system during storage, application and/or curing. The rheology additive prevents, inter alia, sedimentation of the fillers in the polyisocyanate component (A) and/or the amine component (B). It also improves the miscibility of the components and prevents possible phase separation.
The term “temperature resistance” refers to the change in the bond stress of a cured mortar composition at an elevated temperature compared with the reference bond stress. In the context of the present invention, the temperature resistance is specified in particular as the ratio of the bond stress at 80° C. to the reference stress.
“A” or “an” as the article preceding a class of chemical compounds, e.g. preceding the word “filler,” means that one or more compounds included in this class of chemical compounds, e.g. various “fillers,” may be intended.
“At least one” means numerically “one or more”: in a preferred embodiment, the term means numerically “one.”
“Contain” and “comprise” mean that more constituents may be present in addition to the mentioned constituents; these terms are meant to be inclusive and therefore also include “consist of”; “consist of” is meant exclusively and means that no further constituents may be present; in a preferred embodiment, the terms “contain” and “comprise” mean the term “consist of.”

All standards cited in this text (e.g. DIN standards) were used in the version that was current on the filing date of this application.

### Isocyanate Component (A)

The multi-component resin system according to the invention comprises at least one isocyanate component (A) and at least one amine component (B). Before use, the isocyanate component (A) and the amine component (B) are provided separately from one another in a reaction-inhibiting manner.

The isocyanate component comprises at least one polyisocyanate. All aliphatic and/or aromatic isocyanates known to a person skilled in the art and having an average NCO functionality of 2 or more, individually or in any mixtures with one another, can be used 35 as the polyisocyanate. The NCO functionality indicates how many NCO groups are present in the polyisocyanate. Polyisocyanate means that two or more NCO groups are contained in the compound.

Suitable aromatic polyisocyanates are those having aromatically bound isocyanate groups, such as diisocyanatobenzenes, toluene diisocyanates, diphenyl diisocyanates, diphenylmethane diisocyanates, diisocyanatonaphathalenes, triphenylmethane triisocyanates, but also those having isocyanate groups that are bound to an aromatic group via an alkylene group, such as a methylene group, such as bis- and tris-(isocyanatoalkyl) benzenes, toluenes and xylenes.

Preferred examples of aromatic polyisocyanates are: 1,3-phenylene diisocyanate, 1,4-phenylene diisocyanate, 2,4-toluylene diisocyanate, 2,5-toluylene diisocyanate, 2,6-toluylene diisocyanate, 1,3-xylylene diisocyanate, 1,4-xylylene diisocyanate, tetramethyl-1,3-xylylene diisocyanate, tetramethyl-1,4-xylylene diisocyanate, 1,3-bis(isocyanatomethyl)benzene, 1,4-bis(isocyanatomethyl)benzene, ethylphenyl diisocyanate, 2-dodecyl-1,3-phenylene diisocyanate, 2,4,6-triisopropyl-m-phenylene diisocyanate, 2,4,6-trimethyl-1,3-phenylene diisocyanate, xylylene diisocyanate, 1,5-naphthylene diisocyanate, 3,3′-dimethyl-4,4′-biphenyl diisocyanate, 3,3′-dimethoxy-4,4′-biphenyl diisocyanate, 3,3′-dimethyl-4,4′-biphenyl diisocyanate, diphenylene methane-2,4′-diisocyanate, diphenylene methane-2,2′-diisocyanate, diphenylene methane-4,4′-diisocyanate, triphenylmethane-4,4′,4″-triisocyanate, 5-(p-isocyanatobenzyl)-2-methyl-m-phenylene diisocyanate, 4,4-diisocyanato-3,3,5,5-tetraethyldiphenylmethane, 5,5′-ureylene di-o-tolyl diisocyanate, 4-[(5-isocyanato-2-methylphenyl)methyl]-m-phenylene diisocyanate, 4-[(3-isocyanato-4-methylphenyl)methyl]-m-phenylene diisocyanate, 2,2′-methylene-bis[6-(o-isocyanatobenzyl)phenyl] diisocyanate.

Aliphatic isocyanates which have a carbon backbone (without the NCO groups contained) of 3 to 30 carbon atoms, preferably 4 to 20 carbon atoms, are preferably used. Examples of aliphatic polyisocyanates are bis(isocyanatoalkyl) ethers or alkane diisocyanates such as methane diisocyanate, propane diisocyanates, butane diisocyanates, pentane diisocyanates, hexane diisocyanates (e.g. hexamethylene diisocyanate, HDI), heptane diisocyanates (e.g. 2,2-dimethylpentane-1,5-diisocyanate, octane diisocyanates, nonane diisocyanates (e.g. trimethyl HDI (TMDI) usually as a mixture of the 2,4,4- and 2,2,4 isomers), 2-methylpentane-1,5-diisocyanate (MPDI), nonane triisocyanates (e.g. 4-isocyanatomethyl-1,8-octane diisocyanate, 5-methylnonane diisocyanate), decane diisocyanates, decane triisocyanates, undecane diisocyanates, undecane triisocyanates, dodecane diisocyanates, dodecane triisocyanates, 1,3- and 1,4-bis-(isocyanatomethyl)cyclohexane (H_{B}XDI). 3-isocyanatomethyl-3,5,5-trimethylcyclohexyl isocyanate (isophorone diisocyanate, IPDI), bis-(4-isocyanatocyclohexyl)methane (H₁₂MDI), bis-(isocyanatomethyl)norbornane (NBDI) or 3(4)-isocyanatomethyl-1-methyl-cyclohexyl isocyanate (IMCI), octagydro-4,7-methano-1H-indenedimethyl diisocyanate, norbornene diisocyanate, 5-isocyanato-1-(isocyanatomethyl)-1,3,3-trimethylcyclohexane, ureylene-bis(p-phenylenemethylene-p-phenylene)diisocyanate.

Particularly preferred isocyanates are hexamethylene diisocyanate (HDI), trimethyl HDI (TMDI), pentane diisocyanate (PDI), 2-methylpentane-1,5-diisocyanate (MPDI), isophorone diisocyanate (IPDI). 1,3- and 1,4-bis-(isocyanatomethyl)cyclohexane (H₆XDI), bis-(isocyanatomethyl)norbornane (NBDI), 3(4)-isocyanatomethyl-1-methyl-cyclohexyl isocyanate (IMCI) and/or 4,4′-bis(isocyanatocyclohexyl)methane (H₁₂MDI) or mixtures of these isocyanates.

Even more preferably, the polyisocyanates are present as prepolymers, biurets, isocyanurates, iminooxadiazinediones, uretdiones and/or allophanates, which can be produced by oligomerizing difunctional isocyanates or by reacting the isocyanate compounds with polyols or polyamines, individually or as a mixture, and which have an average NCO functionality of 2 or more.

Examples of suitable, commercially available isocyanates are Desmodur® N 3900, Desmodur® N 100, Desmodur® Ultra N 3200, Desmodur® Ultra N 3300. Desmodur® Ultra N 3600, Desmodur® N 3800, Desmodur® XP 2675, Desmodur®2714, Desmodur® 2731, Desmodur® N 3400, Desmodur® XP 2679, Desmodur® XP 2731, Desmodur® XP 2489, Desmodur® E 3370, Desmodur® XP 2599, Desmodur® XP 2617, Desmodur® XP 2406, Desmodur® XP 2551, Desmodur® XP 2838, Desmodur® XP 2840, Desmodur® VL. Desmodur® VL 50. Desmodur® VL 51. Desmodur® ultra N 3300, Desmodur® eco N 7300, Desmodur® E23, Desmodur® E XP 2727, Desmodur® E 30600, Desmodur® E 2863 XPDesmodur® H, Desmodur® VKS 20 F, Desmodur® 44V201, Desmodur® 44P01, Desmodur®44V70 L, Desmodur® N3400, Desmodur® N3500 (all available from Covestro AG), Tolonate™ HDB, Tolonate™ HDB-LV, Tolonate™ HDT, Tolonate™ HDT-LV, Tolonate™ HDT-LV2 (available from Vencorex), Basonat® HB 100, Basonat® HI 100, Basonat® HI 2000 NG (available from BASF), Takenate® 500, Takenate® 600, Takenate® D-132N(NS), Stabio® D-376N (all available from Mitsui), Duranate® 24A-100, Duranate® TPA-100, Duranate® TPH-100 (all available from Asahi Kasai), Coronate® HXR, Coronate® HXLV, Coronate® HX, Coronate® HK (all available from Tosoh).

One or more polyisocyanates are contained in the isocyanate component preferably in a proportion of from 20 to 100 wt. %, more preferably in a proportion of from 30 to 90 wt. % and even more preferably in a proportion of from 35 to 65 wt. %, based on the total weight of the isocyanate component.

### Amine Component (B)

The amine component (B), which is provided separately from the isocyanate component (A) in the multi-component resin system in a reaction-inhibiting manner, comprises at least one amine which is reactive to isocyanate groups and has at least two amino groups as functional groups. According to the invention, the amine has an average NH functionality of 2 or more. The average NH functionality indicates the number of hydrogen atoms bonded to a nitrogen atom in the amine. Accordingly, for example, a primary monoamine has an average NH functionality of 2, a primary diamine has an average NH functionality of 4, an amine having 3 secondary amino groups has an average NH functionality of 3 and a diamine having one primary and one secondary amino group has an average NH functionality of 3. The average NH functionality can also be based on the information provided by the amine supplier, the NH functionality actually indicated possibly differing from the theoretical average NH functionality as it is understood here. The expression “average” means that it is the NH functionality of the compound and not the NH functionality of the amino group(s) contained in the compound. The amino groups can be primary or secondary amino groups. The amine can contain either only primary or only secondary amino groups, or both primary and secondary amino groups.

According to a preferred embodiment, the amine which is reactive to isocyanate groups is selected from the group consisting of aliphatic, alicyclic, araliphatic and aromatic amines, particularly preferably from the group consisting of alicyclic and aromatic amines.

Amines which are reactive to isocyanate groups are known in principle to a person skilled in the art. Examples of suitable amines which are reactive to isocyanate groups are given below, but without restricting the scope of the invention. These can be used either individually or in any mixtures with one another. Examples are: 1,2-diaminoethane (ethylenediamine), 1,2-propanediamine, 1,3-propanediamine, 1,4-diaminobutane, 2,2-dimethyl-1,3-propanediamine (neopentanediamine), diethylaminopropylamine (DEAPA), 2-methyl-1,5-diaminopentane, 1,3-diaminopentane, 2,2,4- or 2,4,4-trimethyl-1,6-diaminohexane and mixtures thereof (TMD), 1,3-bis(aminomethyl)-cyclohexane, 1,2-bis(aminomethyl)cyclohexane, hexamethylenediamine (HMD), 1,2- and 1,4-diaminocyclohexane (1,2-DACH and 1,4-DACH), bis(4-amino-3-methylcyclohexyl)methane, diethylenetriamine (DETA), 4-azaheptane-1,7-diamine, 1,11-diamino-3,6,9-trioxundecane, 1,8-diamino-3,6-dioxaoctane, 1,5-diamino-methyl-3-azapentane, 1,10-diamino-4,7-dioxadecane, bis(3-aminopropyl)amine, 1,13-diamino-4,7,10-trioxatridecane, 4-aminomethyl-1,8-diaminooctane, 2-butyl-2-ethyl-1,5-diaminopentane, N,N-bis(3-aminopropyl)methylamine, triethylenetetramine (TETA), tetraethylenepentamine (TEPA), pentaethylenehexamine (PEHA), 1,3-benzenedimethanamine (m-xylylenediamine, mXDA), 1,4-benzenedimethanamine (p-xylylenediamine, pXDA), 5-(aminomethyl)bicyclo[[2.2.1]hept-2-yl]methylamine (NBDA, norbornane diamine), dimethyldipropylenetriamine, dimethylaminopropylaminopropylamine (DMAPAPA), 2,4-diamino-3,5-dimethylthiotoluene (dimethylthio-toluene diamine DMTDA), 3-aminomethyl-3,5,5-trimethylcyclohexyl amine (isophorone diamine (IPDA)), diaminodicyclohexylmethane (PACM), diethylmethylbenzenediamine (DETDA), 3,3′-diaminodiphenylsulfone (33 dapsone), 3,3′-diaminodiphenylsulfone (dapsone), mixed polycyclic amines (MPCA) (e.g. Ancamine 2168), dimethyldiaminodicyclohexylmethane (Laromin C260), 2,2-bis(4-aminocyclohexyl)propane, (3(4),8(9)bis(aminomethyldicyclo[5.2.1.0^{2,6}]decane (mixture of isomers, tricyclic primary amines; TCD diamine), methylcyclohexyl diamine (MCDA), N,N′-diaminopropyl-2-methyl-cyclohexane-1,3-diamine, N,N′-diaminopropyl-4-methyl-cyclohexane-1,3-diamine, N-(3-aminopropyl)cyclohexylamine, and 2-(2,2,6,6-tetramethylpipeidin-4-yl)propane-1,3-diamine.

Particularly preferred amines are diethylmethylbenzenediamine (DETDA), 2,4-diamino-3,5-dimethylthiotoluene (dimethylthio-toluene diamine, DMTDA), 4,4′-methylene-bis[N-(1-methylpropyl)phenylamine], an isomer mixture of 6-methyl-2,4-bis(methylthio)phenylene-1,3-diamine and 2-methyl-4,6-bis(methylthio)phenylene-1,3-diamine (Ethacure 300), 4,4′-methylenebis(2,6-diethylaniline), 4,4′-methylenebis(N-sec-butylcyclohexanamine) (Clearlink 1000), 3,3′-diaminodiphenylsulfone (33 dapsone), 4,4′-diaminodiphenylsulfone (44 dapsone), N,N′-di-sec-butyl-p-phenylenediamine and 2,4,6-trimethyl-m-phenylenediamine, 4,4′-methylenebis(N-(1-methylpropyl)-3,3′-dimethylcyclohexanamine (Clearlink 3000), the reaction product of 2-propenenitrile with 3-amino-1,5,5-trimethylcyclohexanemethanamine (Jefflink 745) and 3-((3-(((2-cyanoethyl)amino)methyl)-3,5,5-trmethylcyclohexyl)amino)propiononitrile (Jefflink 136 or Baxxodur PC136).

Particularly preferred amines are 4,4′-methylene-bis[N-(1-methylpropyl)phenylamine], an isomer mixture of 6-methyl-2,4-bis(methylthio)phenylene-1,3-diamine and 2-methyl-4,6-bis(methylthio)phenylene-1,3-diamine (Ethacure 300), 4,4′-methylenebis(2,6-diethylaniline), 4,4′-methylenebis(N-sec-butylcyclohexanamine) (Clearlink 1000), 3,3′-diaminodiphenylsulfone (dapsone), N,N′-di-sec-butyl-p-phenylenediamine and 2,4,6-trimethyl-m-phenylenediamine.

One or more amines are preferably contained in the amine component in a proportion of from 20 to 100 wt. %, more preferably in a proportion of from 30 to 70 wt. % and even more preferably in a proportion of from 35 to 70 wt. %, based on the total weight of the amine component.

The quantity ratios of the polyisocyanate component (A) and the amine component (B) of the multi-component resin system are preferably selected such that the ratio of the average NCO functionality of the polyisocyanate compound to the average NH functionality of the amine is between 0.3 and 2.0, preferably between 0.5 and 1.8, more preferably between 0.5 and 1.5, even more preferably between 0.7 and 1.5 and most preferably 0.7 to 1.3.

A mixture of different isocyanates and/or different amines can be used to adjust the rate of curing. In this case, the quantity ratios are selected such that the ratio of the averaged NCO functionality of the isocyanate mixture to the averaged NH functionality of the amine mixture is between 0.3 and 2.0, preferably between 0.5 and 1.8, more preferably between 0.5 and 1.5, even more preferably between 0.7 and 1.5 and most preferably between 0.7 and 1.3.

### Filler

Both the isocyanate component (A) and the amine component (B) can contain at least one filler and at least one rheology additive, it being essential to the invention that at least one of the two components contains both a filler and a rheology additive. It is preferable for both the isocyanate component (A) and the amine component (B) to each contain at least one filler and at least one rheology additive.

The total filling level of a mortar composition produced by mixing the isocyanate component (A) and the amine component (B) of the multi-component resin system is, according to the invention, in a range from 30 to 80 wt. %, based on the total weight of the mortar composition, preferably in a range from 35 to 65 wt. %, more preferably in a range from 35 to 60 wt. %. The total filling level of the mortar composition relates to the percentage by weight of filler and rheological additive based on the total weight of the isocyanate component (A) and the amine component (B). In a preferred embodiment, the filling level of the isocyanate component (A) is from 0 to 80 wt. %, preferably from 10 to 70 wt. %, more preferably from 35 to 65 wt. %, based on the total weight of the isocyanate component (A). The filling level of the amine component (B) is preferably from 0 to 80 wt. %, more preferably from 10 to 70 wt. %, even more preferably from 35 to 65 wt. %, based in each case on the total weight of the amine component (B).

Inorganic fillers, in particular cements such as Portland cement or aluminate cement and other hydraulically setting inorganic substances, quartz, glass, corundum, porcelain, earthenware, barite, light spar, gypsum, talc and/or chalk and mixtures thereof are preferably used as fillers. The inorganic fillers can be added in the form of sands, powders, or molded bodies, preferably in the form of fibers or balls. A suitable selection of the fillers with regard to type and particle size distribution/(fiber) length can be used to control properties relevant to the application, such as rheological behavior, press-out forces, internal strength, tensile strength, pull-out forces and impact strength.

Particularly suitable fillers are quartz powders, fine quartz powders and ultra-fine quartz powders that have not been surface-treated, such as Millisil W3, Millisil W6, Millisil W8 and Millisil W12, preferably Millisil W12. Silanized quartz powders, fine quartz powders and ultra-fine quartz powders can also be used. These are commercially available, for example, from the Silbond product series from Quarzwerke. The product series Silbond EST (modified with epoxysilane) and Silbond AST (treated with aminosilane) are particularly preferred. Furthermore, it is possible for fillers based on aluminum oxide such as aluminum oxide ultra-fine fillers of the ASFP type from Denka, Japan (d₅₀=0.3 μm) or grades such as DAW or DAM with the type designations 45 (d₅₀<0.44 μm), 07 (d₅₀>8.4 μm), 05 (d₅₀<5.5 μm) and 03 (d₅₀<4.1 μm). Moreover, the surface-treated fine and ultra-fine fillers of the Aktisil AM type (treated with aminosilane, d₅₀=2.2 μm) and Aktisil EM (treated with epoxysilane, d₅₀=2.2 μm) from Hoffman Mineral can be used. The fillers can be used individually or in any mixture with one another.

The proportion of fillers in the isocyanate component (A) is preferably from 10 to 70 wt. %, more preferably from 35 to 65 wt. %, based on the total weight of the isocyanate component (A). The proportion of fillers in the amine component (B) is preferably from 10 to 70 wt. %, more preferably from 35 to 65 wt. %, based on the total weight of the amine component (B).

The flow properties are adjusted by adding rheology additives which, according to the invention, are used in the isocyanate component (A) and/or the amine component (B). Suitable rheology additives are: phyllosilicates such as laponites, bentones or montmorillonite, Neuburg siliceous earth, fumed silicas, polysaccharides; polyacrylate, polyurethane or polyurea thickeners and cellulose esters. Wetting agents and dispersants, surface additives, defoamers & deaerators, wax additives, adhesion promoters, viscosity reducers or process additives can also be added for optimization.

The proportion of one or more rheology additives in the isocyanate component (A) is preferably from 0.1 to 3 wt. %, more preferably from 0.1 to 1.5 wt. %, based on the total weight of the isocyanate component (A). The proportion of one or more rheology additives in the amine component (B) is preferably from 0.1 to 5 wt. %, more preferably from 0.5 to 3 wt. %, based on the total weight of the amine component (B).

In a further embodiment, the isocyanate component (A) and/or the amine component (B) can contain at least one adhesion promoter.

By using an adhesion promoter, the cross-linking of the borehole wall with the mortar composition is improved such that the adhesion increases in the cured state. Suitable adhesion promoters are selected from the group of silanes that have at least one Si-bound hydrolyzable group, such as 3-glycidoxypropyltrimethoxysilane, 3-glycidoxypropyltriethoxysilane, 2-(3,4-epoxycyclohexyl)ethyltrimethoxysilane, N-2-(aminoethyl)-3-aminopropylmethyl-diethoxysilane, N-2-(aminoethyl)-3-aminopropyltriethoxysilane, 3-aminopropyl-trimethoxysilane, 3-aminopropyltriethoxysilane, N-phenyl-3-aminoethyl-3-aminopropyl-trimethoxysilane, 3-mercaptopropyltrimethoxysilane and 3-mercaptopropylmethyldimethoxysilane. In particular, 3-glycidoxypropyltrimethoxysilane, 3-aminopropyl-trimethoxysilane (AMMO), 3-aminopropyltriethoxysilane (AMEO), 2-aminoethyl-3-aminopropyl-trimethoxysilane (DAMO) and trimethoxysilylpropyldiethylenetetramine (TRIAMO) are preferred as adhesion promoters. Further silanes are described, for example, in EP3000792 A1.

The adhesion promoter can be contained in the isocyanate component (A) and/or the amine component (B) in an amount of up to 10 wt. %, preferably from 0.1 to 5 wt. %, more preferably from 1.0 to 2.5 wt. %, based on the total weight of the mufti-component resin system.

The invention also relates to a mortar composition which is produced by mixing the isocyanate component (A) and the amine component (B) of the multi-component resin system.

The multi-component resin system is preferably present in cartridges or film pouches which are characterized in that they comprise two or more separate chambers in which the isocyanate component (A) and the amine component (B) are separately arranged in a reaction-inhibiting manner.

For the use as intended of the multi-component resin system, the isocyanate component (A) and the amine component (B) are discharged out of the separate chambers and mixed in a suitable device, for example a static mixer or dissolver. The mixture of isocyanate component (A) and amine component (B) (mortar composition) is then introduced into the previously cleaned borehole by means of a known injection device. The component to be fastened is then inserted into the mortar composition and aligned. The reactive constituents isocyanate component (A) react with the amine groups of the amine component (B) by polyaddition such that the mortar composition cures under environmental conditions within a desired period of time, preferably within a few minutes or hours.

The mortar composition according to the invention or the multi-component resin system according to the invention is preferably used for construction purposes. The expression “for construction purposes” refers to the structural adhesion of concrete/concrete, steel/concrete or steel/steel or one of said materials with other mineral materials, to the structural strengthening of components made of concrete, brickwork and other mineral materials, to reinforcement applications with fiber-reinforced polymers of building objects, to the chemical fastening of surfaces made of concrete, steel or other mineral materials, in particular the chemical fastening of construction elements and anchoring means, such as anchor rods, anchor bolts. (threaded) rods, (threaded) sleeves, reinforcing bars, screws and the like, in boreholes in various substrates, such as (reinforced) concrete, brickwork, other mineral materials, metals (e.g. steel), ceramics, plastics, glass, and wood. Most particularly preferably, the mortar compositions according to the invention and the multi-component resin systems according to the invention are used for the chemical fastening of anchoring means.

The present invention also relates to a method for the chemical fastening of construction elements in boreholes, a mortar composition according to the invention or a multi-component resin system according to the invention being used as described above for the chemical fastening of the construction elements. The method according to the invention is particularly suitable for the structural adhesion of concrete/concrete, steel/concrete or steel/steel or one of said materials with other mineral materials, for the structural strengthening of components made of concrete, brickwork and other mineral materials, for reinforcement applications with fiber-reinforced polymers of building objects, for the chemical fastening of surfaces made of concrete, steel or other mineral materials, in particular the chemical fastening of construction elements and anchoring means, such as anchor rods, anchor bolts, (threaded) rods, (threaded) sleeves, reinforcing bars, screws and the like, in boreholes in various substrates, such as (reinforced) concrete, brickwork, other mineral materials, metals (e.g. steel), ceramics, plastics, glass, and wood. Most particularly preferably, the method according to the invention is used for the chemical fastening of anchoring means.

The present invention also relates to the use of a mortar composition according to the invention or a multi-component resin system for the chemical fastening of construction elements in mineral substrates.

The invention also relates to the use of a mortar composition according to the invention or a multi-component resin system according to the invention for improving the temperature resistance of a chemical anchor produced from a multi-component resin system according to the invention. This includes in particular an increase in the pull-out strengths at high temperatures, such as at 80° C.

The invention is described in greater detail below on the basis of an example which, however, should not be understood in a restrictive sense.

### EXAMPLES

### Components Used:

4,4′-methylene-bis[N-(1-methylpropyl)phenylamine] (from ABCR), aspartic acid. N,N′-(methylenedi-4,1-cyclohexanediyl)bis-,1,1′,4,4′-tetraethyl ester (as Desmophen NH 1420 from Covestro), a mixture of (6-methyl-2,4-bis(methylthio)phenylene-1,3-diamine and 2-methyl-4,6-bis(methylthio)phenylene-1,3-diamine (as Ethacure 300 Curative from Albermale), 4,4′-methylenebis(2,6-diethylaniline) (from TCI) and diethyltoluenediamine (as Ethacure 100 from Albermale) were used as the amine which is reactive to isocyanate groups in the amine component.

Hexamethylene-1,6-diisocyanate homopolymers (as Desmodur N 3600 and N 3900 from Covestro), hexamethylene-1,6-diisocyanate biuret oligomerization product (as Desmodur N 3200 from Covestro) and a mixture of hexamethylene-1,6-diisocyanate homopolymer and isophorone diisocyanate homopolymer (as Desmodur XP 2838 from Covestro) were used as isocyanates in the isocyanate component.

3-aminopropyltriethoxysilane (as Dynasylan AMEO from Evonik) and 3-glycidyloxypropyltrimethoxysilane (as Dynasylan GLYMO from Evonik) were used as adhesion promoters.

Quartz powders (Millisil™ W3 and W12 from Quarzwerke Frechen) and quartz sand (F32 from Quarzwerke Frechen) were used as fillers and silica (Cab-O-Sil™ TS-720 from Cabot Rheinfelden) was used as a thickener.

### COMPARATIVE EXAMPLES

Two commercially available mortar compositions are used as comparative examples: RE500V3 (Hilti, comparative example 1, epoxy resin mortar) and HY200A (Hilti, comparative example 2). The composition listed in the table below, which is based on EP 3 447 078 A1, is used as comparative example 3.

TABLE 1
Composition of comparative example
3 in wt. % based on EP 3447078 A1

| Constituent | Comparative example 3 |
|---|---|
| Isocyanate component | |
| Hexamethylene-1,6- | 24.4 |
| diisocyanate homopolymer | |
| (N3900) | |
| Quartz powder (W12) | 14.4 |
| Silica | 0.6 |
| Amine component | |
| Aspartic acid, N,N′- | 37.6 |
| (methylenedi-4,1- | |
| cyclohexanediyl)bis-,1,1′,4,4′- | |
| tetraethyl ester | |
| Quartz powder (W12) | 22.1 |
| Silica | 0.9 |
| Isocyanate:amine ratio | 1:1 |
| Filling level in % | 38 |

### Examples According to the Invention

The compositions according to the invention of the isocyanate component and the amine component are shown in Tables 2 and 3 below.

TABLE 2
Compositions of the isocyanate component and the
amine component [wt. %] for examples 1 to 7 according
to the invention; use of different amines.

| | | 1 | 2 | 3 | 4 | 5 | 6 | 7 |
|---|---|---|---|---|---|---|---|---|
| Iso- | Hexamethylene- | 38.9 | 39.6 | 36.4 | 37.7 | 37.9 | 33.4 | 39.0 |
| cyanate | 1,6-diisocyanate | | | | | | | |
| com- | homopolymer | | | | | | | |
| ponent | (N3900) | | | | | | | |
| | Quartz powder | 22.9 | 24.2 | 21.4 | 22.2 | 22.3 | 19.6 | 23.0 |
| | (W12) | | | | | | | |
| | Silica | 0.9 | 1.0 | 0.9 | 0.9 | 0.9 | 0.9 | 0.9 |
| Amine | 4,4′-methylene- | — | — | 12.8 | 6.1 | — | 22.9 | — |
| com- | bis[N-(1- | | | | | | | |
| ponent | methylpropyl) | | | | | | | |
| | phenylamine] | | | | | | | |
| | (6-methyl-2,4- | 23.1 | 23.4 | 12.8 | 18.2 | 19.2 | — | 21.9 |
| | bis(methylthio) | | | | | | | |
| | phenylene- | | | | | | | |
| | 1,3-diamine/2- | | | | | | | |
| | methyl-4,6- | | | | | | | |
| | bis(melhylthio) | | | | | | | |
| | phenylene- | | | | | | | |
| | 1,3-diamine | | | | | | | |
| | (DMTDA) | | | | | | | |
| | 4,4′-methyl- | — | — | — | — | 4.8 | 5.7 | — |
| | enebis(2,6- | | | | | | | |
| | diethylaniline) | | | | | | | |
| | Diethyltoluene- | — | — | — | — | — | — | 1.1 |
| | diamine | | | | | | | |
| | (DETDA) | | | | | | | |
| | Quartz powder | 13.5 | 11.2 | 15.1 | 14.3 | 14.2 | 16.9 | 13.5 |
| | (W12) | | | | | | | |
| | Silica | 0.7 | 0.5 | 0.6 | 0.6 | 0.6 | 0.6 | 0.6 |
| | Isocyanate: | 1:1 | 1:1 | 1:1 | 1:1 | 1:1 | 1:1 | 1:1 |
| | amine ratio | | | | | | | |
| | Filling level | 38 | 37 | 38 | 38 | 38 | 38 | 38 |
| | in % | | | | | | | |

TABLE 3
Compositions of the isocyanate component and the amine
component [wt. %] for examples 8 to 16 according to the
invention; examples 8 to 10: variation of isocyanate; examples
11 to 14: variation of fillers and filling level; examples
15 and 16: addition of silane.

| | | 8 | 9 | 10 | 11 | 12 | 13 | 14 | 15 | 16 |
|---|---|---|---|---|---|---|---|---|---|---|
| Iso- | Hexamethylene- | 40.3 | — | — | — | — | — | — | — | — |
| cyanate | 1,6-diisocyanate | | | | | | | | | |
| com- | homopolymer/ | | | | | | | | | |
| ponent | isophorone | | | | | | | | | |
| | diisocyanate | | | | | | | | | |
| | homopolymer | | | | | | | | | |
| | (XP2838) | | | | | | | | | |
| | Hexamethylene- | — | 40.1 | — | — | — | — | — | — | — |
| | 1,6-diisocyanate | | | | | | | | | |
| | biuret | | | | | | | | | |
| | oligomerization | | | | | | | | | |
| | product (N3200) | | | | | | | | | |
| | Hexamethylene- | — | — | 39.2 | — | — | — | — | — | — |
| | 1,6-diisocyanate | | | | | | | | | |
| | homopolymer | | | | | | | | | |
| | (N3600) | | | | | | | | | |
| | Hexamethylene- | — | — | — | 31.4 | 25.1 | 38.9 | 38.9 | 39.3 | 38.3 |
| | 1,6-diisocyanate | | | | | | | | | |
| | homopolymer | | | | | | | | | |
| | (N3900) | | | | | | | | | |
| | Quartz sand | — | — | — | — | — | — | 22.9 | — | — |
| | (F32) | | | | | | | | | |
| | Quartz powder | — | — | — | — | — | 22.9 | — | — | — |
| | (W3) | | | | | | | | | |
| | Quartz powder | 23.7 | 23.6 | 23.6 | 30.5 | 36.7 | — | — | 22.4 | 21.4 |
| | (W12) | | | | | | | | | |
| | Silica | 1.0 | 1.0 | 1.0 | 0.9 | 0.9 | 0.9 | 0.9 | 0.9 | 0.9 |
| Amine | (6-methyl-2,4- | 21.7 | 22.0 | 22.8 | 18.6 | 14.9 | 23.1 | 23.1 | 22.8 | 23.7 |
| com- | bis(methylthio) | | | | | | | | | |
| ponent | phenylene-1,3- | | | | | | | | | |
| | diamine/ | | | | | | | | | |
| | 2-methyl-4,6- | | | | | | | | | |
| | bis(methyithio) | | | | | | | | | |
| | phenylene- | | | | | | | | | |
| | 1,3-diamine | | | | | | | | | |
| | (DMTDA) | | | | | | | | | |
| | 3-amino- | — | — | — | — | — | — | — | 1.1 | — |
| | propyl- | | | | | | | | | |
| | trimethoxy- | | | | | | | | | |
| | silane | | | | | | | | | |
| | Quartz sand | — | — | — | — | — | — | 13.6 | — | — |
| | (F32) | | | | | | | | | |
| | Quartz powder | — | — | — | — | — | 13.6 | — | — | — |
| | (W3) | | | | | | | | | |
| | Quartz powder | 12.8 | 12.9 | 12.9 | 18.0 | 21.8 | — | — | 13.0 | 13.2 |
| | (W12) | | | | | | | | | |
| | Silica | 0.5 | 0.5 | 0.5 | 0.6 | 0.6 | 0.6 | 0.6 | 0.6 | 0.6 |
| | Isocyanate: | 1:1 | 1:1 | 1:1 | 1:1 | 1:1 | 1:1 | 1:1 | 1:1 | 1:1 |
| | amine ratio | | | | | | | | | |
| | Filling level | 38 | 38 | 38 | 50 | 60 | 38 | 38 | 37 | 36 |
| | in % | | | | | | | | | |

### Mortar Compositions and Dull-Out Tests

To produce the mortar compositions, the isocyanate component and the amine component were each first produced individually. For this purpose, the constituents shown in Tables 1 to 3 were added together and mixed with one another. The liquid isocyanate and amine components produced in this way were each mixed in a speed mixer (DAC-600 from Hauschild) for 30 seconds at 1500 rpm. The isocyanate component and the amine component were then combined with one another and mixed in a speed mixer for 30 seconds at 1500 rpm. The mortar composition obtained in this way was filled into a hard cartridge and injected into a borehole using an extrusion device.

The pull-out strength of the mortar compositions obtained by mixing the isocyanate component and the amine component according to the above examples was determined using a high-strength anchor threaded rod M12, which was doweled into a hammer-drilled borehole having a diameter of 14 mm and a borehole depth of 72 mm by means of the relevant mortar composition in C20/25 concrete. The boreholes were cleaned by means of compressed air (2×6 bar), a wire brush (2×) and again by compressed air (2×6 bar).

The boreholes were filled up, by two thirds from the bottom of the borehole, with the mortar composition to be tested in each case. The threaded rod was pushed in by hand. After curing, the mortar ring protruding from the borehole was cut off.

To determine the reference bond stress, after a curing time of 24 hours at a temperature of 23° C., the failure load was determined by centrally pulling out the threaded anchor rod with close support.

To determine the bond stress at 80° C., after a curing time of 24 hours at a temperature of 23° C., the concrete blocks were heated to 80° C. and held at that temperature for 24 hours. Immediately after removing the concrete slabs from the oven, the failure load at 80° C. was determined by centrally pulling out the threaded anchor rod with close support.

The bond stresses obtained with the mortar compositions are shown in Tables 4 to 6 below.

TABLE 4
Results of the determination of the reference bond stress
at 23° C. after a curing time of 24 hours and the
bond stress at 80° C. for comparative examples 1 to 3.

| | Comparative | Comparative | Comparative |
|---|---|---|---|
| | example 1 | example 2 | example 3 |
| Pull-out tests | Bond stress [N/mm²] | | |
| Reference | 39 | 32 | 26.0 |
| 80° C. | 16 | 25 | 1.8 |
| Ratio | 0.41 | 0.78 | 0.07 |

TABLE 5
Results of the determination of the reference bond stress
at 23° C. after acuring time of 24 hours and the bond
stress at 80° C. for comparative examples 1 to 7.

| | 1 | 2 | 3 | 4 | 5 | 6 | 7 |
|---|---|---|---|---|---|---|---|
| Pull-out tests | Bond stress [N/mm²] | | | | | | |
| Reference | 23.5 | 24.4 | 29.9 | 26.1 | 24.8 | 27.2 | 25.0 |
| 80° C. | 22.8 | 23.0 | 15.5 | 19.0 | 25.5 | 17.5 | 23.5 |
| Ratio | 0.97 | 0.94 | 0.52 | 0.73 | 1.03 | 0.64 | 0.94 |

* not determinable

TABLE 6
Results of the determination of the reference bond stress at
23° C. after a curing time of 24 hours and the bond stress at
80° C. for examples 8 to 16 according to the invention.

| | 8 | 9 | 10 | 11 | 12 | 13 | 14 | 15 | 16 |
|---|---|---|---|---|---|---|---|---|---|
| Pull-out tests | Bond stress [N/mm²] | | | | | | | | |
| Reference | 18.2 | 25.6 | 22.7 | 25.5 | 26.6 | 22.6 | 20.4 | 23.5 | 26.0 |
| 80° C. | 23.6 | 20.1 | 22.9 | 23.3 | 23.6 | 23.5 | 23.7 | 20.7 | 24.7 |
| Ratio | 1.30 | 0.78 | 1.01 | 0.92 | 0.89 | 1.04 | 1.16 | 0.89 | 0.95 |

1: A multi-component resin system, containing:
at least one isocyanate component (A), and
at least one amine component (B),
wherein the at least one isocyanate component (A) comprises
at least one aliphatic and/or aromatic polyisocyanate having an average NCO functionality of 2 or more,
wherein the at least one amine component (B) comprises
at least one amine which is reactive to isocyanate groups and has an average NH functionality of 2 or more,
wherein the multi-component resin system is free of polyaspartic acid esters, and the at least one isocyanate component (A) and/or the at least one amine component (B) comprises at least one filler and at least one rheology additive, and
wherein a total filling level of a mortar composition produced by mixing the at least one isocyanate component (A) and the at least one amine component (B) is in a range from 30 to 80%, based on the g total weight of the multi-component resin system.

2: The multi-component resin system according to claim 1, wherein both the at least one isocyanate component (A) and the at least one amine component (B) comprise the at least one filler and the at least one rheological additive.

3: The multi-component resin system according to claim 2, wherein a filling level of the at least one isocyanate component (A) and a filling level of the at least one amine component (B) is from 10 to 70 wt. %, based in each case on a total weight of the at least one isocyanate component (A) and the at least one amine component (B), respectively.

4: The multi-component resin system according to claim 1, wherein the at least one isocyanate component (A) and the at least one amine component (B) are present in a quantity ratio in which the average NCO functionality to the average NH functionality is between 0.3 and 2.0.

5: The multi-component resin system according to claim 1, wherein the at least one isocyanate component (A) comprises at least one aromatic polyisocyanate selected from the group consisting of 1,4-phenylene diisocyanate, 2,4- and 2,6-toluylene diisocyanate, xylylene diisocyanate, hydrogenated xylylene diisocyanate, tetramethylxylylene diisocyanate, 1,5-naphthylene diisocyanate, diphenylene methane-2,4′- and -4,4′-diisocyanate, triphenylmethane-44′,4-triisocyanate, bis- and tris-(isocyanatoalkyl)-benzene, toluene, and xylene.

6: The multi-component resin system according to claim 1, wherein the at least one isocyanate component (A) comprises at least one aliphatic polyisocyanate selected from the group consisting of hexamethylene diisocyanate (HDI), trimethyl HDI (TMDI), pentane diisocyanate (PDI), 2-methylpentane-1,5-diisocyanate (MPDI), isophorone diisocyanate (IPDI), 1,3- and 1,4-bis(isocyanatomethyl)cyclohexane (H6XDI), bis(isocyanatomethyl)norbornane (NBDI), 3(4)-isocyanatomethyl-1-methyl-cyclohexyl isocyanate (IMCI), and 4,4′-bis (isocyanatocyclohexyl)methane (H12MDI).

7: The multi-component resin system according to claim 1, wherein the total filling level is in a range from 35 to 65 wt. %, based on the total weight of the multi-component resin system.

8: The multi-component resin system according to claim 1, wherein the at least one isocyanate component (A) and/or the at least one amine component (B) contain at least one adhesion promoter.

9: The multi-component resin system according to claim 1, wherein the at least one amine which is reactive to isocyanate groups is selected from the group consisting of 4,4′-methylene-bis[N-(1-methylpropyl)phenylamine], an isomer mixture of 6-methyl-2,4-bis(methylthio)phenylene-1,3-diamine and 2-methyl-4,6-bis(methylthio)phenylene-1,3-diamine, 4,4′-methylenebis(2,6-diethylaniline), 4,4′-methylenebis(N-sec-butylcyclohexanamine), 3,3′-diaminodiphenylsulfone, N,N′-di-sec-butyl-p-phenylenediamine, 2,4,6-trimethyl-m-phenylenediamine, and a mixture thereof.

10: The multi-component resin system according to claim 1, wherein the multi-component resin system is a two-component resin system.

11: A mortar composition, produced by mixing the at least one isocyanate component (A) and the at least one amine component (B) of the multi-component resin system according to claim 1.

12: A method, comprising:
chemically fastening a construction element in a borehole, with the mortar composition according to claim 11.

13: A method of improving temperature resistance of a chemical anchor, comprising:
curing the mortar composition according to claim 11, to obtain the chemical anchor.

14: The method according to claim 13, wherein the chemical anchor has improved pull-out strength at 80° C.

15: A method, comprising:
chemically fastening a construction element in a borehole, with the multi-component resin system according to claim 1.

16: A method of improving temperature resistance of a chemical anchor, comprising:
mixing the multi-component resin system according to claim 1, to obtain a mortar composition, and
curing the mortar composition, to obtain the chemical anchor.

17: The method according to claim 16, wherein the chemical anchor has improved pull-out strength at 80° C.
